(19) United States
(12) Patent Application Publication
(10) Pub. No.: US 2003/0111765 A1
(43) Pub. Date: Jun. 19, 2003

(54) Method for joining resinous products by effectively heating joining surfaces

(76) Inventors: Masato Ichikawa, Kariya-City (JP); Hisashi Kayano, Toyoake-City (JP); Tsutomu Onoue, Kariya-City (JP); Manabu Ishiguro, Kariya-City (JP); Toshiaki Nakayama, Nishikamo-gun (JP)

Correspondence Address: NIXON & VANDERHYE, PC, 1100 N GLEBE ROAD, 8TH FLOOR, ARLINGTON, VA, 22201-4714, US

(21) Appl. No.: 10/321,588

(22) Filed: Dec. 18, 2002

(30) Foreign Application Priority Data
Dec. 18, 2001 (JP) 2001-384712
Nov. 18, 2002 (JP) 2002-333968

(51) Int. Cl. B29C 45/16; B29C 65/02

(52) U.S. Cl. 264/248; 264/250

(57) ABSTRACT

A method which can prevent primary mold products from being deformed or broken during a secondary molding process to improve joining strength of joining portions.

In the method for joining a plurality of primary mold products 6, 7, formed by a separate process with each other, in a secondary molding process, a secondary mold resin 13 is injected to joining portions 12 after the surfaces 10 and 11 of the joining portion 12 of the primary mold products 6, 7 to be joined have been heated.

### BACKGROUND OF THE INVENTION

1. Field of the Invention

The present invention relates to a method for joining resinous products such as intake-manifolds or others.

2. Description of the Related Art

A method for joining resinous products has been disclosed in Japanese Unexamined Patent Publication (Kokai) Nos. 62-87315 and 4-91914, wherein a stationary mold and a movable mold, which can be used for both first molding and second molding, are used for the first molding of a plurality of primary mold products and directly thereafter the movable mold is made to slide or rotate to abut the plurality of primary mold products to each other. A secondary mold resin is then ejected to the abutted portions to join the plurality of primary mold products to each other to complete the secondary mold product.

Also, another method for joining resinous products is disclosed in Japanese Unexamined Patent Publication (Kokai) No. 6-238707, wherein a plurality of primary mold products molded in a separate process are abutted to each other in a secondary mold and resin is ejected to the abutted portions to join the plurality of primary mold products to complete the secondary mold product.

In the former joining method, the secondary molding is carried out directly after the primary molding, whereby the interior of the plurality of primary mold products is maintained at a high temperature to weaken the strength thereof during the secondary molding process. Accordingly, the primary mold products are liable to be deformed or broken by a pressure of resin during the secondary molding.

In the latter joining method, there is a problem in that when the cooled and solidified primary mold products are subjected to the secondary molding process at room temperature, the ejected secondary mold resin is hardened excessively to lower the joining strength of resin.

### SUMMARY OF THE INVENTION

An object of the present invention is to solve the above-mentioned problems in the prior art by providing a method for joining resinous products capable of preventing the primary mold products from being deformed or broken during the secondary molding process as well as improving the joining strength thereof.

A method for joining resinous products according to a first aspect of the present invention comprises a secondary molding process, in which a plurality of primary mold products molded in a separated process, are joined together by injecting a secondary molding resin into joining portions of the primary mold products after only the surface areas of joining surfaces of the primary mold products to be joined together have been heated.

According to the method for joining the resinous products as defined in the first aspect, as only the surface areas of the primary mold products to be joined together are heated, it is possible to prevent the strength of the primary mold products from lowering as a whole due to heat, thus to prevent the primary mold products from being deformed and broken due to the pressure of resin during the secondary molding process. Also, since areas to be heated are reduced, it is possible to reduce the heat capacity to shorten the heating time and to save heating energy.

A method for joining resinous products according to a second aspect of the present invention comprises a secondary molding process, in which a plurality of primary mold products molded by a separated process, are joined together by forming tubular paths with joining surfaces of the primary mold products to be joined together by abutting the joining surfaces with each other and by injecting a secondary mold resin into the tubular paths after heating the joining surfaces by supplying a heating medium into the tubular paths.

According to the method for joining the resinous products as defined in the second aspect, as the joining surfaces are formed by the tubular paths, the heating medium fed from ends of the tubular paths can easily reach all over the joining surfaces and heat hardly escapes from the joining surfaces. Thereby, it is possible to heat the joining surfaces with a less heating energy. Also, since portions of the primary mold products other than the joining surfaces thereof are not directly heated, it is possible to prevent the primary mold products from being deformed or broken due to the pressure of resin during the secondary molding process.

In a method for joining resinous products of a third aspect of the present invention according to the second aspect, at least a heating medium feeding port for feeding the heating medium into the tubular paths is disposed at an end of the tubular paths on a side different from at least a secondary mold resin injection port located on an end of the tubular paths.

According to the method for joining the resinous products as defined in the third aspect, as the heating medium feeding port and the secondary mold resin injection port are disposed at ends of the tubular paths different from each other, ends of flowing paths of the secondary mold resin, which temperature is inherently liable to lower because a flowing path length of the secondary resin is long, is closer to the heating medium feeding port. Thereby, the temperature drop of the secondary mold resin, which is significant as the secondary mold resin reaches the ends of the flowing paths of the secondary mold resin, can be suppressed when the same flows through the primary mold products, as well as a decreased amount of heat in the secondary mold resin, when the same reaches the ends of the flowing paths thereof, can be supplemented by an amount of heat previously imparted to the joining surfaces of the primary mold products, which enhances the merging of the resin of the secondary molding process with that of the primary mold products to maintain a high joining strength between the both.

In a method for joining resinous products of a fourth aspect of the present invention according to the third aspect, the tubular path branches into a plurality of branch tubular paths, which means that the present invention is applicable to a product having a complicated joining surfaces.

In a method for joining resinous products of a fifth aspect of the present invention according to the fourth aspect, the number of the heating medium feeding ports is more than that of the secondary mold resin injection ports.

According to the method for joining resinous products as defined in the fifth aspect, as the number of the heating medium feeding ports is more than that of the secondary mold resin injection ports, more heating medium is supplied to the secondary mold resin injection port which becomes the exit side of the heating medium so that the temperature of the heating medium is inherently liable to lower thereat. Thus, the temperature of the joining surface in the vicinity of the secondary mold resin injection port rises, whereby the temperature drop of the secondary mold resin is suppressed to maintain the joining strength at a high level.

In a method for joining resinous products of a sixth aspect of the present invention according to the fifth aspect, the tubular paths branched into a plurality of branch tubular paths are arranged so that the heating medium supplied from the heating medium feeding port are collected to the secondary mold resin injection port.

According to the method for joining resinous products as defined in the sixth aspect, as the heating medium fed from the heating medium feeding ports are collected to the secondary mold resin injection port, more heating medium is supplied to the secondary mold resin injection port which becomes the exit side of the heating medium so that the temperature of heating medium is inherently liable to lower thereat. Thereby, the temperature of the joining surfaces in the vicinity of the secondary mold resin injection port rises to suppress the temperature drop of the secondary mold resin to maintain the joining strength at a high level.

In a method for joining resinous products according to a seventh aspect of the present invention is one as defined in any one of the first to sixth aspects wherein the heating medium is a heated air.

According to the method for joining resinous products as defined in the seventh aspect, as the heating medium is heated air, the medium is inexpensive and can be easily handled. Also, as the secondary molding process is carried out while no heating medium is left on the joining surfaces, the adhesive property of the joining surfaces is not degraded.

According to a method for joining resinous products of an eighth aspect of the present invention, as the same resin is used for forming the first mold products and for injection of the secondary molding process, the respective resin is easily molten together to result in a high joining strength when hardened.

According to a method for joining resinous products of a ninth aspect of the present invention, as the secondary molding is an injection molding, it is possible to join the molten secondary mold resin to the primary mold products at a high pressure to result in a high joining strength when hardened.

The present invention may be more fully understood from the description of the preferred embodiments of the present set forth below, together with the accompanying drawings.

### BRIEF DESCRIPTION OF THE DRAWINGS

In the drawings:

FIG. 1 is a perspective view of a resinous product obtained by a method for joining resinous products according to one embodiment of the present invention;

FIG. 2 is a sectional view of the above-mentioned resinous product taken along a line II-II in FIG. 1;

FIG. 3 is an illustration of a process for carrying out the above-mentioned joining method in correspondence to the section taken along a line III-III in FIG. 1; and

FIG. 4 is an illustration of the process for carrying out the above-mentioned joining method in correspondence to a plan view of the resinous product shown in FIG. 1.

### DESCRIPTION OF THE PREFERRED EMBODIMENTS

The embodiments of the present invention will be described below with reference to the attached drawings.

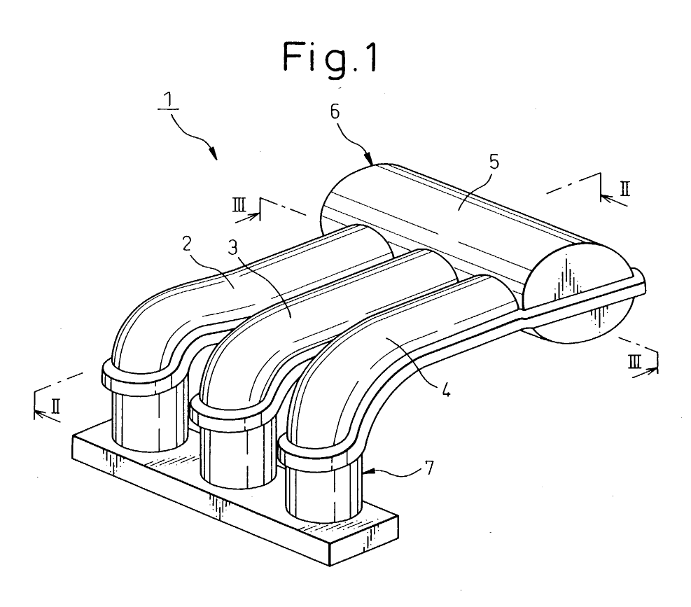

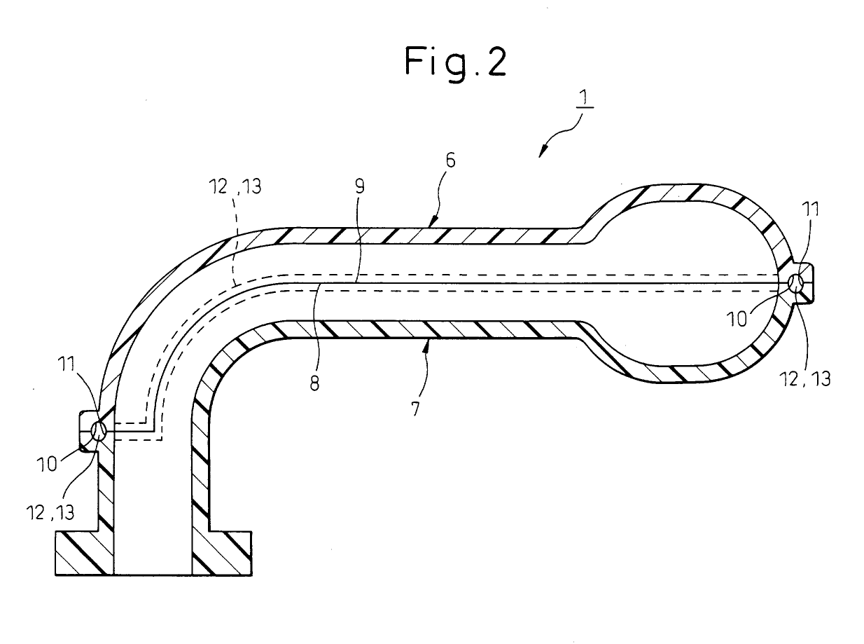

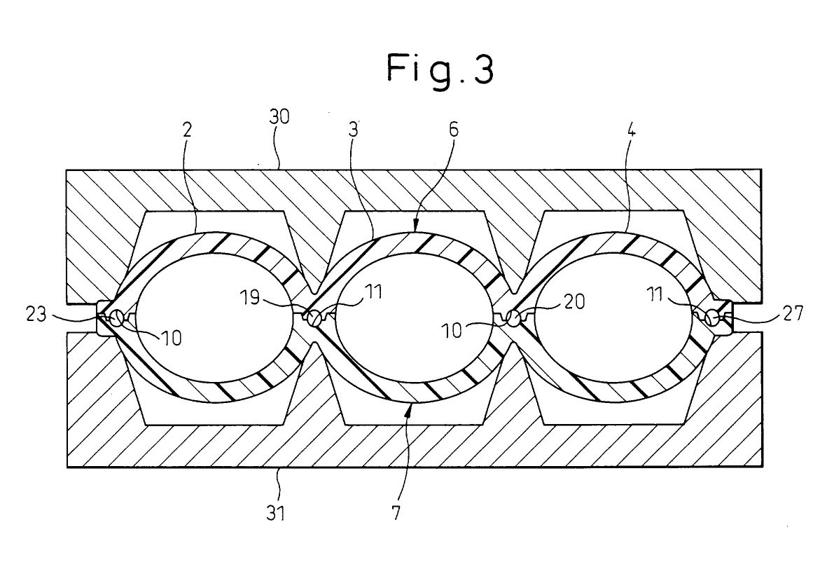

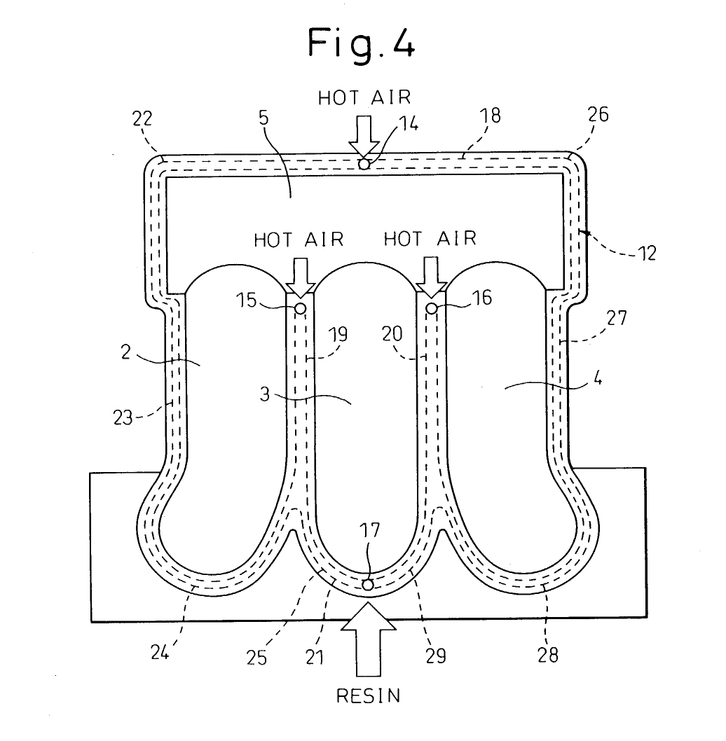

FIG. 1 is a perspective view of a resinous product obtained by carrying out a method for joining resinous products according to one embodiment of the present invention; FIG. 2 is a sectional view of the above-mentioned resinous product; and FIGS. 3 and 4 are illustrations, respectively, of a process for the above-mentioned joining method.

A resinous product 1 shown in FIGS. 1 and 2 is a hollow intake manifold for a three-cylinder engine. The intake manifold 1 is provided with three pipes 2, 3 and 4 and a surge tank 5 for communicating these pipes 2, 3 and 4. The intake manifold 1 is formed by joining two primary mold products 6 and 7 of a half-split pipe shape, molded by a separated process, that is, a primary molding process, through a secondary molding process. On the end surfaces 8, 9 of the respective primary mold products 6, 7, joining surfaces 10, 11 forming a groove of a substantially semicircular cross-section extend throughout the entire circumference thereof. The joining surfaces 10, 11 abut to each other during the secondary molding process to provide tubular paths having a substantially circular cross-section, that is, joining portions 12. By injecting a secondary mold resin 13 into the tubular paths 12 the two primary mold products 6, 7 are joined together, resulting in a secondary mold product, i.e., the intake manifold 1.

A method for producing the intake manifold 1 will be described below with reference to FIGS. 3 and 4.

First, the two primary mold products 6 and 7 are molded by using primary molds not shown. The primary mold products 6, 7 may be made, for example, of nylon resin (PA6).

Then, the joining surfaces 10, 11 of the two primary mold products 6, 7 are abutted to each other. By this abutment of the joining surfaces 10, 11, the tubular paths 12 of a substantially circular cross-section are formed. Three heating medium feeding ports 14, 15 and 16 and one secondary mold resin injection port 17, as shown in FIG. 4, communicate the tubular paths 12. The heating medium feeding ports 14, 15 and 16 and the secondary mold resin injection port 17 are formed in advance in either one or both of the two primary mold products 6, 7. In this regard, the heating medium feeding ports 14, 15 or 16 are entrances for feeding the heating medium into the tubular paths 12, while the secondary mold resin injection port 17 is an entrance for injecting the secondary mold resin 13 into the tubular paths 12. As illustrated in FIG. 4, the first heating medium feeding port 14 of the three heating medium feeding ports 14, 15 and 16 is located at a center of a linear tubular path section 18 extending leftward and rightward of the surge tank 5; the second heating medium feeding port 15 is located at an end, closer to the surge tank 5, in the linear tubular path section 19 extending forward and rearward in a plan view, between a left side pipe 2 and a central pipe 3; and the third heating medium feeding port 16 is located at an end, closer to the surge tank 5, in the linear tubular path section 20 extending forward and rearward in a plan view, between a right side pipe 4 and the central pipe 3. As illustrated in FIG. 4, the secondary mold resin injection port 17 is located at a center in an arcuate tubular path section 21, of the central pipe 3, which is arcuate in a plan view.

Next, the heating medium is fed into the tubular paths 12 from each of the first, second and third heating medium feeding ports 14, 15 and 16 to heat the joining surfaces 10 and 11 of the tubular paths 12, that is, only the surfaces of the joining portions. The heating medium is a heated air, that is, a hot air.

The heating medium fed from the first heating medium feeding port 14 is immediately bifurcated to the left and right directions. The heating medium directed to the leftward passes a left side L-shaped tubular path section 22 of the surge tank, a left side linear tubular path section 23, extending forward and rearward in a plan view, of the left side pipe 2, an arcuate tubular path 24 of the left side pipe 2 and a left side portion 25 of the arcuate tubular path section 21 of the central pipe 3. Thereafter, the heating medium is discharged from the secondary mold resin injection port 17. The heating medium directed to the rightward passes a right side L-shaped tubular path section 26 of the surge tank, a right side linear tubular path section 27, extending forward and rearward in a plan view, of the right side pipe 4, an arcuate tubular path section 28 of the right side pipe 4 and a right side portion 29 of the arcuate tubular path section 21 of the central pipe 3. Thereafter, the heating medium is discharged from the secondary mold resin injection port 17.

The heating medium fed from the second heating medium feeding port 15 passes a linear tubular path section 19 between the left side pipe 2 and the central pipe 3 and the left side portion 25 of the arcuate tubular path section 21 of the central pipe 3 and thereafter is discharged from the secondary mold resin injection port 17.

The heating medium fed from the third heating medium feeding port 16 passes a linear tubular path section 20 between the right side pipe 4 and the central pipe 3 and the right side portion 29 of the arcuate tubular path section 21 of the central pipe 3 and thereafter is discharged from the secondary mold resin injection port 17.

As stated above, after the heating medium is fed into the tubular paths 12 to heat the joining surfaces 10, 11, the secondary molding process is carried out. In the secondary molding process, secondary molds 30, 31, as shown in FIG. 3, are used and the secondary mold resin 13 is injected or ejected from the secondary mold resin injection port 17 into the tubular path 12, so that the two primary mold products 6 and 7 are joined together. The secondary mold resin 13 is of the same kind as that of the primary mold products 6 and 7, for example, nylon resin (PA6).

The secondary mold resin 13 injected from the secondary mold resin injection port 17 is immediately bifurcated to the left and right directions. The secondary mold resin 13 directed to the left side passes the left side portion 25 of the arcuate tubular path section 21 of the central pipe 3, and thereafter is branched to the linear tubular path section 19 between the left side pipe 2 and the central pipe 3 and the arcuate tubular path section 24 of the left side pipe 2. The secondary mold resin 13 branched to the linear tubular path section 19 reaches the second heating medium feeding port 15. The secondary mold resin 13 branched to the arcuate tubular path section 24 passes the left side linear tubular path section 23 of the left side pipe 2 and the left side L-shaped tubular path section 22 of the surge tank 5, and thereafter reaches the first heating medium feeding port 14. The secondary mold resin 13 branched to the right side passes the right side section 29 of the arcuate tubular path section 21 of the central pipe 3, and thereafter, is divided into the linear tubular path section 20 between the right side pipe 4 and the central pipe 3 and the arcuate tubular path section 28 of the right side pipe 4. The secondary mold resin 13 divided into the linear tubular path section 20 reaches the third heating medium feeding port 16. The secondary mold resin 13 branched to the arcuate tubular path section 28 passes the right side linear tubular path section 27 of the right side pipe 4 and the right side l-shaped tubular path section 26 of surge tank 5, and thereafter reaches the first heating medium feeding port 14.

Thereafter, the secondary mold resin 13 is hardened to result in the intake manifold 1 shown in FIG. 1.

As stated above, according to the method for joining the resinous products of this embodiment, a plurality of primary mold products 6, 7 molded in a separate process are joined together in a secondary molding process, wherein after only surfaces 10, 11 of joining portions 12 of the primary mold products 6, 7 to be joined together has been heated, the secondary mold resin 13 is injected into the joining portions 12. Accordingly, it is possible to prevent the strength of the primary mold products 6, 7, as a whole, from being degraded due to the heat, whereby the deformation or the breakage of the primary mold products 6, 7 is avoidable, due to the resin pressure, during the secondary molding process. Also, as the areas to be heated are reduced, a heat capacity and a heating time necessary for the process can be decreased to save the heating energy consumption.

According to the method for joining the resinous products of this embodiment, wherein a plurality of primary mold products 6, 7 molded by a separate process are joined together in the secondary molding process, the joining surfaces 10, 11 of the respective primary mold products 6, 7 to be joined together are abutted to each other to provide tubular paths 12, into which a heating medium is fed to heat the joining surfaces 10, 11, and then the secondary mold resin 13 is injected into the tubular paths 12. As the joining surfaces 10, 11 define the tubular paths 12 in such a manner, if the heating medium is injected into the tubular paths 12 from one end thereof, it is easily spread throughout the joining surfaces 10, 11 and heat is left there for a long time. Thus, it is possible to heat the joining surfaces 10, 11 with less heat energy. Since no heat is directly applied to portions of the primary mold products 6, 7 other than the joining surfaces 10, 11 thereof, it is possible to avoid the deformation and breakage of the primary mold products 6, 7 due to the pressure of resin during the secondary molding process.

The heating medium feeding ports 14, 15 and 16 for feeding the heating medium into the tubular paths are disposed at end areas of different sides from the secondary mold resin injection port 17 provided at the end of the tubular paths 12. Concretely, the first heating medium feeding port 14 and the secondary mold resin injection port 17 are located at one and the other end, respectively, of the tubular path portions defined by the left side L-shaped tubular path section 22, the left side linear tubular path section 23, the arcuate tubular path section 24 and the left side portion 25 of the arcuate tubular path section 21, and are located at one end and the other end, respectively, of the tubular path portions defined by the right side L-shaped tubular path section 26, the right side linear tubular path section 27, the arcuate tubular path section 28 and the right side portion 29 of the arcuate tubular path section 21. Also, the second heating medium feeding port 15 and the secondary mold resin injection port 17 are located at one end and the other end, respectively, of the tubular path portions defined by the linear tubular path section 19 and the left side portion 25 of the arcuate tubular path section 21; while the third heating medium feeding port 16 and the secondary mold resin injection port 17 are located at one end and the other end, respectively, of the tubular path portions defined by the linear tubular path section 20 and the right side portion 29 of the arcuate tubular path section 21. In other words, the end of the flowing paths of the secondary mold resin 13, of which the temperature is inherently liable to drop because of the large flowing path lengths, is disposed in the vicinity of the heating medium feeding ports 14, 15 and 16. Thus, the surface temperature of the joining surfaces 10, 11 existing at the end of the flowing paths of the secondary mold resin 13 rises, whereby the temperature drop of the secondary mold resin, at the flowing end thereof, during the passage thereof in the primary mold products is avoidable, and, also, the decrease of heat energy of the secondary mold resin at the end of the flowing paths thereof can be supplemented by a heat energy supplied in advance to the joining surfaces of the primary mold products, so that the molten resin of secondary molding are easily merged into that of the primary mold products to maintain the joining strength at a high level.

The tubular paths 12 are branched to a plurality of branch paths. Concretely, the tubular paths 12 have a branch path starting from the first heating medium feeding port 14, through the left side L-shaped tubular path section 22, the left side linear tubular path section 23, the arcuate tubular path section 24 and the left side portion 25 of the arcuate tubular path section 21 and reaching the secondary mold resin injection port 17; a branch path starting from the first heating medium feeding port 14, through the right side L-shaped tubular path section 26, the right side linear tubular path section 27, the arcuate tubular path section 28 and the left side portion 29 of the arcuate tubular path section 21 and reaching the secondary mold resin injection port 17; a branch path starting from the second heating medium feeding port 15, through the linear tubular path section 19, the left side portion 25 of the arcuate tubular path section 21 and reaching the secondary mold resin injection port 17; and a branch path starting from the third heat medium feeding port 16, through the linear tubular path section 20 and the right side portion 29 of the arcuate tubular path portion 21 and reaching the secondary mold resin injection port 17. The present invention is also applicable to the product 1 having such complicated joining surfaces 10, 11.

As the number of the heating medium feeding ports 14, 15 and 16 is larger than that of the secondary mold resin injection ports 17, more heating medium is supplied to the secondary medium injection port 17 at which temperature of the heating medium is inherently liable to be lowered because the injection port 17 is disposed on the exit side of the heating medium. Thereby, the surface temperature of the joining surfaces 10, 11 in the vicinity of the secondary mold resin injection port 17 rises to suppress the temperature drop of the secondary mold resin 13 and to maintain the joining strength at a high level. In this regard, the number of the heating medium feeding ports and that of the secondary mold resin injection ports should not be limited to three and one, respectively, as described in the preceding embodiment, but it is only necessary that the number of the heating medium feeding ports is larger than that of the secondary mold resin injection ports.

As the tubular paths 12, branched into a plurality branch paths as described above, are arranged so that the heating medium fed from the heating medium feeding ports 14, 15 and 16 are collected to the secondary mold resin injection port 17, more heating medium is supplied to the secondary medium injection port 17 at which the temperature of the heating medium is inherently liable to fall because the injection port 17 is disposed on the exit side of the heating medium. Therefore, the surface temperature of the joining surfaces 10, 11 in the vicinity of the secondary mold resin injection port 17 rises to suppress the temperature drop of the secondary mold resin 13 and to maintain the joining strength at a high level.

As the heating medium is a hot air, the medium is inexpensive and can be easily treated. Since the secondary molding process is carried out under the condition wherein no heating medium is left on the joining surfaces 10, 11, the adhesive property of the joining surfaces 10, 11 is not deteriorated.

As the resin for forming the primary mold products 6, 7 and the resin 13 for carrying out the secondary molding are of the same kind, the respective resins are well merged to each other to result in a high joining strength after hardening.

As the secondary molding is carried out by the injection molding process, the molten secondary mold resin 13 can be merged to the primary mold products 6, 7 under a high pressure to result in a high joining strength after hardening.

According to the method for joining the resinous products of the present invention, it is possible to prevent the primary mold products from being deformed or broken during the secondary molding process as well as to enhance the joining strength.

While the invention has been described by reference to specific embodiments chosen for the purposes of illustration, it should be apparent that numerous modifications could be made thereto by those skilled in the art without departing from the basic concept and scope of the invention.

What is claimed is:

1. A method for joining resinous products comprises a secondary molding process in which a plurality of primary mold products molded in a separated process are joined together by injecting a secondary molding resin into joining portions of the primary mold products after only the surface areas of the joining portions of the primary mold products to be joined together have been heated.

2. A method for joining resinous products comprises a secondary molding process in which a plurality of primary mold products molded in a separated process are joined together by forming tubular paths with joining surfaces of the primary mold products to be joined together by abutting the joining surfaces with each other and by injecting a secondary mold resin into the tubular paths after heating the joining surfaces by supplying a heating medium into the tubular paths.

3. A method for joining resinous products as defined in claim 2, wherein at least a heating medium feeding port for feeding the heating medium into the tubular paths is disposed at an end of the tubular paths on the side different from at least a secondary mold resin injection port located on an end of the tubular paths.

4. A method for joining resinous products as defined in claim 3, wherein the tubular paths branch into a plurality of branch tubular paths.

5. A method for joining resinous products as defined in claim 4, wherein the number of the heating medium feeding ports is more than that of the secondary mold resin injection ports.

6. A method for joining resinous products as defined in claim 5, wherein the tubular paths branched into a plurality of branch tubular paths are arranged so that the heating medium supplied from the heating medium feeding port are collected to the secondary mold resin injection port.

7. A method for joining resinous products as defined in claim 1, wherein the heating medium is a heated air.

8. A method for joining resinous products as defined in claim 1, wherein the same resin is used for forming the first mold products and for injection in the secondary molding process.

9. A method for joining resinous products as defined in claim 1, wherein the secondary molding is an injection molding.

10. A method for joining resinous products as defined in claim 2, wherein the heating medium is a heated air.

11. A method for joining resinous products as defined in claim 2, wherein the same resin is used for forming the first mold products and for injection in the secondary molding process.

12. A method for joining resinous products as defined in claim 2, wherein the secondary molding is an injection molding.
